(19) United States
(12) Patent Application Publication
(10) Pub. No.: US 2026/0360284 A1
(43) Pub. Date: Nov. 12, 2026

(54) BACKLIT ADVERTISING PLATFORM

(71) Applicant: CELLING 5G NETWORK, S.L., Madrid (ES)

(72) Inventor: Guillermo SAINZ FUERTES, Madrid (ES)

(21) Appl. No.: 19/131,660

(22) PCT Filed: Nov. 22, 2022
(86) PCT No.: PCT/ES2022/070754

§ 371 Date: May 21, 2025

(51) Int. Cl. G09F 13/18; G09F 13/04; G09F 13/08; G09F 13/22

(52) U.S. Cl. CPC G09F 13/18; G09F 13/0409; G09F 13/0413; G09F 13/0456; G09F 13/049; G09F 13/08; G09F 2013/1836; G09F 2013/222

(57) ABSTRACT

An advertising platform is provided that can be illuminated, for visibility when ambient light is low, but without showing an interior. The advertising platform comprises a frame with a housing, electronic modules arranged in the housing, a casing that embraces the frame, and one or more backlit panels, arranged in the housing of the frame, making contact with the side faces of the casing, and comprising a first semi-transparent thermoplastic panel, a first transparent thermoplastic sheet a second thermoplastic panel highly transparent to light, flexible LED strips, arranged making contact with the second panel, on one or more sides of an outer perimeter, so that an entire surface is illuminated and diffuses the light, and a second opaque rigid plastic sheet.

### OBJECT OF THE INVENTION

The object of the present invention is a backlit advertising platform, which can be illuminated to make it more visible when ambient light is low. In addition, the advertising platform is illuminated without creating shadows or showing its interior, in which different elements can be arranged, such as 5G small cells, without interfering with them.

### BACKGROUND OF THE INVENTION

Currently, advertising signs or platforms with a variety of shapes: banners, monoliths, posts, etc., are known in the state of the art. In addition, it is known that these advertising platforms can be illuminated, to make them more visible during periods when ambient light is low.

The traditional lighting systems in these advertising platforms normally consist of fluorescent tubes arranged in the inner central portion of the platform, or more recently, LED strips arranged around the perimeter inside the platform.

Moreover, in recent times different electronic modules have been incorporated inside these advertising platforms to equip them with different functionalities, such as improving mobile coverage, allowing Wi-Fi connection or facilitating induction recharging of mobile devices. In the case of improving coverage, 5G micro-antennas or “small cells” are incorporated into the advertising platform, in order to provide the required coverage to urban centres, along highways or to extra-urban areas thus requiring it.

However, a problem arises when it comes to illuminating these advertising signs comprising electronic modules inside, since it is not possible to do it in the same way as was previously done with the signs that did not comprise any additional element. This is due to the fact that the means traditionally used to illuminate the advertising platform are not adapted, so that all its content, that is, all the electronic modules placed inside, can be appreciated from the outside.

In this way, a visual effect is produced that is not the desired one, since the content of the platform is seen against the light, and the advertising sign cannot be clearly displayed.

In addition, a second problem consists in the fact that the lighting systems in advertising platforms known to date are not accessible from the outside, since the advertising platform does not comprise any electronic module that requires regular maintenance. In the case of advertising platforms with electronic modules, easy access to their interior is necessary, since these elements require periodic maintenance.

In view of the previous problems, it is necessary to develop a device that allows solving them, so that the advertising sign can be illuminated, without showing the electronic modules that are located inside the same, and allowing access to facilitate its maintenance.

### DESCRIPTION OF THE INVENTION

The object of the present invention is a backlit advertising platform, which allows solving the aforementioned problems, since it achieves lighting without shadows and without showing its interior, making it easier to correctly display advertising. In addition, in the event that the advertising platform comprises an electronics module, the backlighting is innocuous for the radio signal.

Therefore, the present invention focusses on a backlit advertising platform, comprising:
a frame, intended to be attached to a fixed surface, such as a wall or the floor, on which a housing is defined,
one or more electronic modules arranged in the housing, the electronic module being a radio antenna, or more preferably a 5G “small cell” micro-antenna or an RFID antenna, among others,
a casing that embraces the frame, which is in the shape of an orthogonal prism and has an open rear face through which the frame is inserted, as well as a front side face, a rear side face, a top face and a bottom face,
one or more backlit modules, arranged in the housing of the frame, making contact with at least one of the side faces of the casing, and comprising:
   a support structure,
   a first semi-transparent thermoplastic panel, making contact with one of the side faces of the casing,
   a first transparent thermoplastic sheet, arranged after the first semi-transparent thermoplastic panel, on a face opposite to the side face of the casing, the function of which is that of allowing a projected light to pass through,
   a second thermoplastic panel that is highly transparent to light, arranged making contact with the transparent thermoplastic sheet, on a face opposite to the first semi-transparent thermoplastic panel,
   flexible LED strips, attached to the support structure and arranged making contact with the second thermoplastic panel, on one or more sides of its outer perimeter, so that its entire surface is illuminated and diffuses the light,
   a second opaque rigid plastic sheet, making contact with the second thermoplastic panel, on a face opposite to the first thermoplastic sheet, the function of which is that of cancelling the light projected by the LED strips and diffused by the second thermoplastic panel, avoiding the shadows of the electronic modules arranged in the housing of the frame, and
   attachment elements for attaching the first and second sheets and the first and second panels to the support structure.

The front and rear faces of the casing are preferably made of a transparent material, such as vinyl, so that they do not interfere with the backlit modules.

By means of this configuration, the concealment of the electronic modules is achieved, their shadows being avoided when the backlit module is activated. In addition, the backlit module is harmless to the radio signal generated by the electronic modules (5G antennas).

The first semi-transparent thermoplastic panel is preferably methacrylate. More preferably, the first thermoplastic panel is opal methacrylate, which is a thermoplastic characterised by its transparency, lightness, and resistance to weathering.

The transparent thermoplastic sheet is preferably made of PET (polyethylene terephthalate).

The second thermoplastic panel is preferably methacrylate. More preferably, the second thermoplastic panel is made of Optical Methacrylate (PMMA, polymethylmethacrylate) with a high degree of light transparency.

The second opaque rigid plastic sheet is preferably made of white PVC (Polyvinyl Chloride).

Additionally, to facilitate accessibility and maintenance, the backlit module may comprise casters, arranged in the support structure, which make it easier to insert the backlit module into the housing of the frame.

### DESCRIPTION OF THE DRAWINGS

As a complement to the description provided herein, and for the purpose of helping to make the features of the invention more readily understandable, in accordance with a preferred practical exemplary embodiment thereof, said description is accompanied by a set of drawings constituting an integral part of the same, in which by way of illustration and not limitation, the following has been represented:

FIG. 1.—Shows a perspective view of the pennant-type backlit sign.

FIG. 2.—Shows a cross-sectional view of the pennant-type backlit sign.

FIG. 3.—Shows a perspective view of the backlit module.

FIG. 4.—Shows a cross-sectional view of the backlit module.

FIG. 5.—Shows a detailed view of the support structure.

FIG. 6.—Shows a detailed view of the guide wheels of the frame and the casing.

### PREFERRED EMBODIMENT OF THE INVENTION

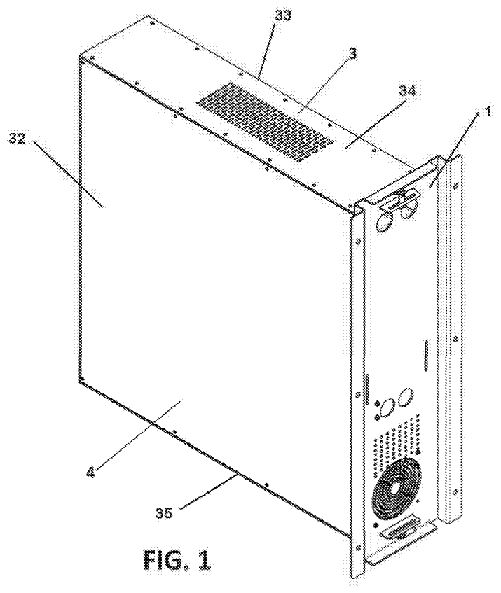

A preferred embodiment of the backlit advertising platform, object of the present invention, is described below with the help of FIGS. 1 to 6.

FIG. 1 shows a general representation of the backlit advertising platform, which comprises, first of all, a frame (1) in which a housing is defined.

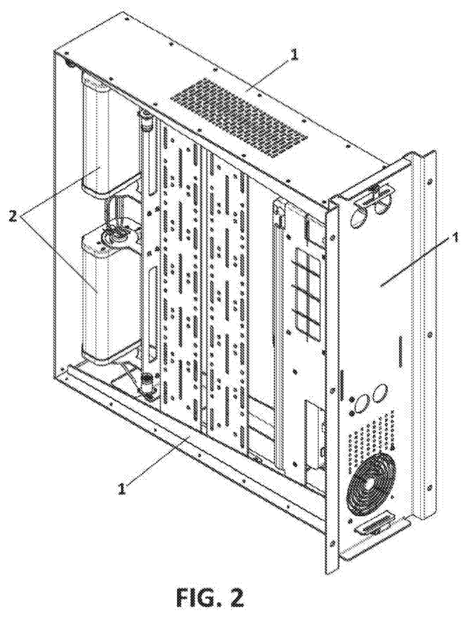

As shown in the section of FIG. 2, one or more electronic modules (2) are arranged in the housing of the frame (1), which in this case are 5G “small cell” microantennas.

The advertising platform further comprises a casing (3) that embraces the frame (1), and which is in the shape of an orthogonal prism and has an open rear face (31) through which the frame (1) is inserted, as well as a front side face (32), a rear side face (33), a top face (34) and a bottom face (35).

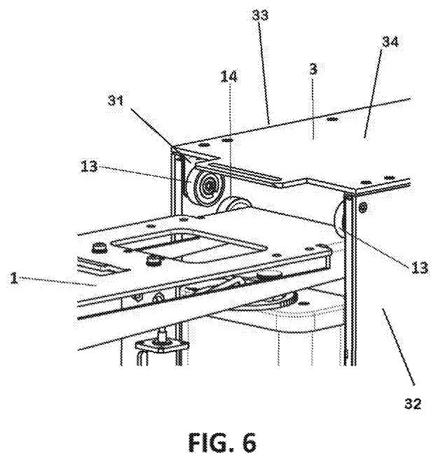

To facilitate the placement of the casing (3) on the frame (1), as shown in FIG. 6, wherein the frame (1) additionally comprises, at a second end opposite to the first end intended to be attached to the fixed surface, first wheels (14) arranged vertically and facing each other intended to establish contact with the top and bottom faces (34, 35) of the casing (3), during the movement of the casing (3) with respect to the frame (1). In addition, the casing (3) comprises in the inner area of its front side face (32) and rear side face (33) second wheels (13) arranged vertically and facing each other, which are located in the vicinity of the open rear face (31) of the casing (3) and move guided on the frame (1).

Preferably, the wheels (13, 14) are made of a plastic material, so as not to interfere with the electronic modules (2).

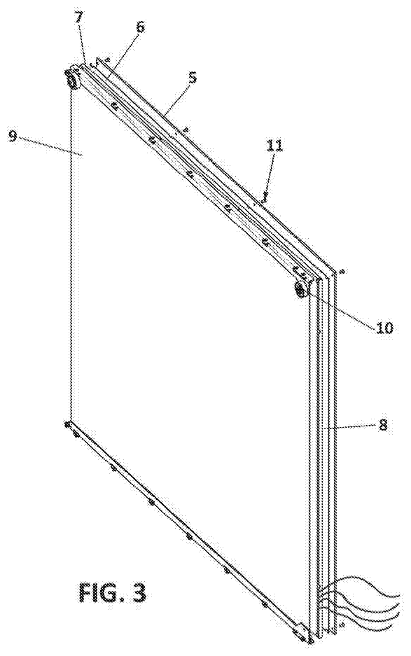

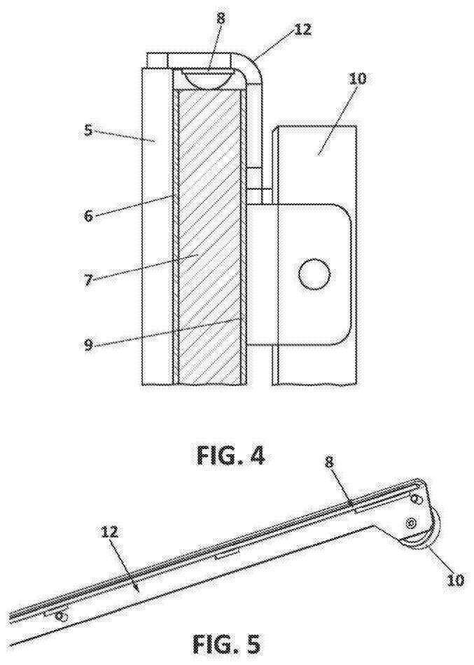

In order to make the advertising platform more visible in low light situations, the same comprises one or more backlit modules (4), arranged in the housing of the frame (1), making contact with one of the side faces of the casing (3), and which is shown in detail in FIG. 3 in a general view, and in FIG. 4 in a cross-sectional detail view.

The backlit module (4) comprises, first of all, a support structure (12), which is shown in detail in FIG. 5. Moreover, as reflected in FIG. 4, it comprises a first panel (5) made of opal methacrylate, making contact with the side face of the casing (3). The side face of the casing (3) is made of a transparent material, so that it does not interfere with the backlit module (4).

Next, a first sheet (6) made of PET (polyethylene terephthalate) is arranged after the first panel (5) of opal methacrylate, on a face opposite to the side face of the casing (3), the function of which is that of allowing a projected light to pass through.

In addition, the backlit module (4) comprises a second panel (7) made of Optical Methacrylate (PMMA, polymethylmethacrylate) with a high degree of light transparency, around 92%, arranged making contact with the first PET sheet (6), on one side opposite to the first panel (5) made of opal methacrylate.

In order to illuminate the advertising platform, the backlit module (4) further comprises LED strips (8), preferably flexible, to facilitate the placement thereof, attached to the support structure (12) and arranged making contact with the second Optical Methacrylate panel (7), on one or more sides of its outer perimeter, such that they project light on its entire surface, this light being diffused by the second panel (7).

Finally, the backlit module (4) comprises a second opaque PVC sheet (9), making contact with the second Optical Methacrylate panel (7), on a face opposite to the first PET sheet (6), the function of which is that of cancelling the light projected by the LED strips (8) and diffused by the second Optical Methacrylate panel (7), avoiding the shadows of the electronic modules (2) arranged in the housing of the frame (1).

Additionally, the backlit module comprises attachment means (11), which are shown in FIG. 3, to link the first and second sheets (4, 6) and the first and second panels (5, 7) to the support structure (12). The attachment means (11) can be screws, which go through the sheets (4, 6) and panels (5, 7) and are inserted into corresponding inserts arranged in the support structure (12).

In addition, as shown in FIG. 3, the backlit module (4) can include casters (10), arranged in the support structure (12), which make it easier to insert the backlit module (4) into the housing of the frame (1). Specifically, as shown in FIG. 3, the backlit module (4) comprises two casters (10) arranged on a top edge of the support structure (12). In addition, the casters (10) are preferably made of a plastic material, since if they were metallic they could generate intermodulation products with the support structure (12), and affect the electronic modules (2).

Moreover, with respect to the structure of the frame (1) and casing (3) of the advertising platform, in a first embodiment of the invention, it has the shape of a banner, as shown in FIGS. 1 and 2. In this case, the casing (3) is essentially flat-shaped, an advertising image being arranged on at least one of its side faces. In addition, in this case, the advertising platform comprises attachment means on the central face of the edge opposite to the open side of the casing (3), to enable the attachment thereof to a banner-shaped vertical wall. The banner-shaped advertising platform may comprise one or two backlit panels (4). In the case of comprising two, each of them is arranged making contact with one of the side faces of the casing (3).

In a second embodiment of the invention, the advertising platform has the shape of a monolith, wherein the casing (3) is essentially flat-shaped, an advertising image being arranged on one or more of its side faces. In addition, in this case, the advertising platform includes attachment means associated with the central face of the edge opposite to the open side of the casing (3), to attach it to the ground as a monolith. As in the previous case, the advertising platform in the form of a monolith may comprise one or two backlit panels (4). In the case of comprising two, each of them is arranged making contact with one of the side faces of the casing (3).

In a third embodiment of the invention, the advertising platform has the shape of a billboard, wherein the casing (3) is essentially flat-shaped, an advertising image being arranged on one or more of its side faces. In addition, the advertising platform comprises attachment means comprising at least one essentially vertical rigid post protruding from the profile of the casing (3) for attachment thereof to the ground as a billboard. As in the previous cases, the advertising platform in the form of a billboard may comprise one or two backlit panels (4). In the case of comprising two, each of them is arranged making contact with one of the side faces of the casing (3).

1. A backlit advertising platform, comprising:
a frame having a first side intended to be fixed to a fixed surface, wherein the frame delimits a housing,
one or more electronic modules arranged in the housing,
a casing that embraces the frame, which is in the shape of an orthogonal prism and has an open rear face through which the frame is inserted, as well as a front side face, a rear side face and top and bottom faces,
one or more backlit panels, located in the housing of the frame making contact with at least one of the side faces of the casing, wherein each backlit panel comprises:
a support structure
a first semi-transparent thermoplastic panel, making contact with one of the side faces of the casing,
a first transparent thermoplastic sheet, arranged after the first panel
a second transparent thermoplastic panel, arranged making contact with the first sheet,
LED strips, attached to the support structure and arranged making contact with the second panel, on one or more sides of an outer perimeter, such that an entire surface is illuminated,
a second opaque rigid plastic sheet making contact with the second panel, and
fastener attaching the first panel, the first sheet, the second panel and the second sheet to the support structure

2. The advertising platform of claim 1, wherein the electronic module is a radio antenna.

3. The advertising platform of claim 2, wherein the radio antenna is a 5G small cell.

4. The advertising platform of claim 1, wherein the first semi-transparent thermoplastic panel is made of methacrylate.

5. The advertising platform of claim 1, wherein the first thermoplastic panel is made of opal methacrylate.

6. The advertising platform of claim 1, wherein the first transparent thermoplastic sheet is made of PET (polyethylene terephthalate).

7. The advertising platform of claim 1, wherein the second thermoplastic panel is made of methacrylate.

8. The advertising platform of claim 1, wherein the second thermoplastic panel is made of Optical Methacrylate (PMMA, polymethyl methacrylate).

9. The advertising platform of claim 1, wherein the second sheet is made of opaque PVC (Polyvinyl Chloride).

10. The advertising platform of claim 1, wherein:
the first semi-transparent thermoplastic panel is made of opal methacrylate.
the first transparent thermoplastic sheet is made of PET (polyethylene terephthalate),
the second thermoplastic panel is made of Optical Methacrylate (PMMA, polymethyl methacrylate), and
the second sheet is made of opaque PVC (Polyvinyl Chloride).

11. The advertising platform of claim 1, wherein the backlit module comprises casters, arranged in the support structure, which facilitate the insertion of the backlit module into the frame housing.

12. The advertising platform of claim 1, comprising a single backlit module arranged making contact with one of the side faces of the casing.

13. The advertising platform of claim 1, comprising two backlit panels each arranged making contact with one of the side faces of the casing.

14. The advertising platform of claim 1, wherein the frame additionally comprises, at a second end opposite to the first end intended to be attached to the fixed surface, first wheels arranged vertically and facing each other intended to establish contact with the top and bottom faces of the casing, during the movement of the casing with respect to the frame and moreover, the casing comprises second wheels-in the inner area of a front side face and rear side face arranged, vertically and facing each other, which are located in the vicinity of the open rear face of the casing and move guided on the frame.

15. The advertising platform of claim 1, wherein the frame comprises a post to enable the attachment thereof to a banner-shaped vertical wall.

16. The advertising platform of claim 1, wherein the casing is essentially flat-shaped, and the advertising platform comprises the post linked to the casing, enabling the attachment thereof to the ground as a monolith.

17. The advertising platform of claim 1, wherein the casing is essentially flat-shaped, and the advertising platform additionally comprises at least one essentially vertical rigid post protruding from the profile of the casing for attachment thereof to the ground as a billboard.
